(19) United States
(12) Patent Application Publication
(10) Pub. No.: US 2010/0131728 A1
(43) Pub. Date: May 27, 2010

(54) COMPUTER-READABLE RECORDING MEDIUM STORING DATA MIGRATION PROGRAM, DATA MIGRATION METHOD, AND DATA MIGRATION APPARATUS

(75) Inventors: Takeshi MIYAMAE, Kawasaki (JP); Yoshitake Shinkai, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/619,650

(22) Filed: Nov. 16, 2009

(30) Foreign Application Priority Data
Nov. 21, 2008 (JP) 2008-298197

(51) Int. Cl. G06F 12/16; G06F 12/00; G06F 12/02

(52) U.S. Cl. 711/162; 711/165; 711/E12.001; 711/E12.002; 711/E12.103

(57) ABSTRACT

A data migration apparatus migrating data from a first storage to a second storage includes a switching unit for switching a destination of an I/O request issued by a business application from a device node of the first storage to a device node of the second storage; a copying unit for copying data stored in the first storage to the second storage; a transferring unit for transferring the I/O request to the device node of the first storage; an executing unit for executing the read or write process on the first storage; a re-copying unit for re-copying target data of the write process from the first storage to the second storage; and a stopping unit for stopping the transfer of the I/O request to the device node of the first storage.

### CROSS-REFERENCE TO RELATED APPLICATION

This application is based upon and claims the benefit of priority of the prior Japanese Patent Application No. 2008-298197, filed on Nov. 21, 2008, the entire contents of which are incorporated herein by reference.

### FIELD

A certain aspect of the embodiment relates to a technique for migrating data between storages in a computer system.

### BACKGROUND

In operation of a computer system, for system maintenance, data is migrated between storage (external storage apparatuses) provided in respective servers to rewrite the storages. In the data migration operation, first, processing by a business application is stopped in order to prevent the business application from transmitting I/O (Input/Output) requests to the storages during the data migration. Then, data stored in a source storage is copied to a destination storage. Moreover, the destination of I/O requests issued by the business application to the storages is changed from the source storage to the destination storage. The processing by the business application is then resumed.

In recent years, the increased amount of processing by business applications has led to an increase in the capacity of the storage provided in each server and in the amount of data to be migrated for the data migration between the storages. This tends to increase the time required to copy the data in the source storage to the destination storage and the time for which business application needs to be stopped. On the other hand, the number of systems providing services 24 hours a day, every day, for example, services provided using the Internet, has been increasing. Thus, copying data while the processing by the business application is stopped has been difficult. Consequently, the following technique has been proposed. That is, along with the processing by the business application, the data in the source storage is copied to the destination storage. At this time, the destination of I/O requests issued by the business application remains the source storage after the beginning of the data copying. Thus, a subsystem controlling the storages references a table in which the source storage is associated with the destination storage, to determine the destination storage. The subsystem then changes the destination of the I/O request to the destination storage, which then processes the I/O request. At this time, when the I/O request is for execution of a read or write process on data that has not completely been copied to the destination storage yet, the subsystem copies target data to the destination storage and then carries out the read or write process (Japanese Unexamined Patent Application Publication No. 2008-65486).

However, with the above-described technique, even after the data copying is completed, unless the business application switches the destination of the I/O request, the subsystem needs to continuously change the destination of the I/O request from the source storage to the destination storage. Such a change process is redundant and otherwise unnecessary for accesses to storages, and may delay the processing by the business application. To avoid such a change process if at all possible, a system administrator desirably switches settings immediately after the copying of data to the destination storage has been completed, so as to set the destination of I/O requests issued by the business application to the destination storage. However, it is difficult for the system administrator to accurately predict when the copying of data is completed. This is because the time required for data migration not only depends on the amount of data to be migrated, the throughput of the server, or the like, but also varies according to the amount by which the storage is updated in response to an I/O request issued by the business application during the migration. Thus, the system administrator needs to monitor when the copying of data is completed in order to re-set the destination of I/O requests issued by the business application at the time of the completion of the copying of data.

### SUMMARY

In accordance with an aspect of embodiments, a data migration apparatus migrating data from a first storage to a second storage includes a switching unit for switching a destination of an I/O request issued by a business application from a device node of the first storage to a device node of the second storage; a copying unit for copying data stored in the first storage to the second storage; a transferring unit for transferring the I/O request to the device node of the first storage when the I/O request issued by the business application during the copying of the data is for execution of a read process or a write process at least on the data stored in the storage; an executing unit for executing the read or write process on the first storage in accordance with the request for execution of the read or write process transferred to the device node of the first storage; a re-copying unit for re-copying the data of the write process from the first storage to the second storage when the write process executed on the first storage is intended at least for the data already copied from the first storage to the second storage; and a stopping unit for stopping the transfer of the I/O request to the device node of the first storage when the copying of the data to the second storage is completed.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram showing the general configuration of a data migration apparatus;

FIG. 2 is a diagram of data migration procedures;

FIG. 3A is a diagram illustrating reassignment of a drive letter or the like by an OS and illustrating a state before the reassignment;

FIG. 3B is a diagram illustrating the reassignment of the drive letter or the like by the OS and illustrating a state after the reassignment;

FIG. 4 is a flowchart of processing carried out when a migration manager receives an I/O request;

FIG. 5 is a flowchart of a background copy process carried out by the migration manager; and

FIG. 6 is a diagram illustrating a bit map.

### DESCRIPTION OF EMBODIMENTS

In view of the above-described issues, an object of an aspect of the present invention is to allow data to be migrated between storages in such a manner that a system administrator need not switch the destination of I/O requests from a business application when copying of data from a source storage to a destination storage is completed.

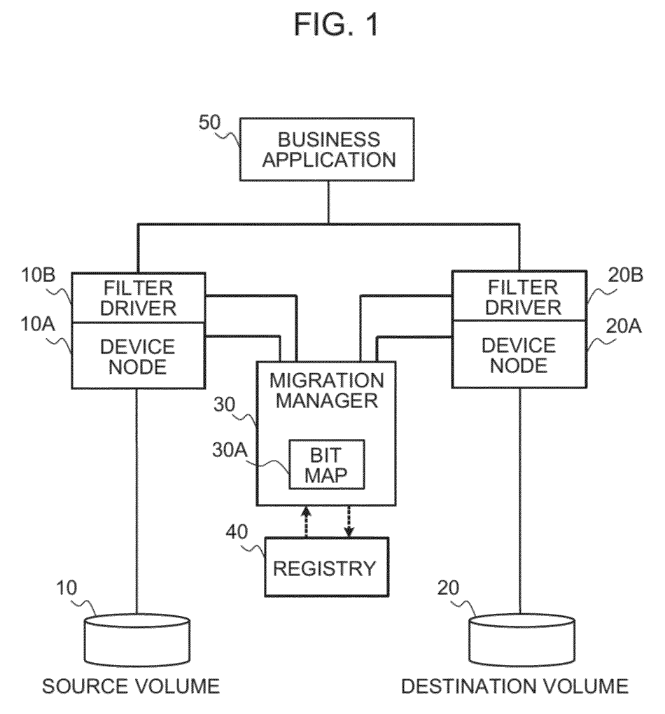

FIG. 1 illustrates a general configuration of a data migration apparatus implementing a data migration mechanism migrating data between storages. The components of the apparatus are implemented in an environment in which an operating system (hereinafter referred to as an “OS”) operates in a server including at least a CPU (Central Processing Unit) and a memory. As illustrated in FIG. 1, the present apparatus includes a source volume 10, a device node 10A and a filter driver 10B corresponding to the source volume 10, a destination volume 20, a device node 20A and a filter driver 20B corresponding to the destination volume 20, a migration manager 30, a bit map 30A used by the migration manager 30, a registry 40, and a business application 50.

The source volume 10 is a storage serving as a data source in the present data migration mechanism. Data used by the business application 50 is stored in the source volume 10. Before data migration, the destination of I/O requests issued by the business application 50 is the source volume 10 based on a drive letter or mount point (hereinafter referred to as a drive letter or the like) assigned by the OS.

A device node 10A functions as an interface controlling the source volume 10 for the business application 50.

A filter driver 10B functions as an upper filter for the device node 10A. The filter driver 10B intercepts and passes an I/O request transmitted to the device node 10A, to the migration manager 30, serving as a library, as required. I/O requests issued by the business application 50 include requests for execution of a read or write process on data stored in the volume (data stored in the storage), requests for setting volume attributes (a partition information acquisition request, a mount request, a volume reservation or release request, and the like), and a volume application notification. I/O request data (IRP: I/O Request Packet) includes a device node corresponding to the volume of the destination of an I/O request and information enabling the above-described type of the I/O request to be determined. If the I/O request is for execution of a read or write process on the data stored in the volume, the I/O request data further includes identifiers for data blocks to which target data for the read or write process belongs, and the data length of the target data.

The destination volume 20 is a storage to which data is to be migrated. The data stored in the source volume 10 is copied to the destination volume 20.

Like the device node 10A corresponding to the source volume 10, the device node 20A functions as an interface controlling the destination volume 20 for the business application 50.

Like the filter driver 10B corresponding to the source volume 10, the filter driver 20B functions as an upper filter for the device node 20A. The filter driver 20B intercepts and passes an I/O request transmitted to the device node 20A, to the migration manager 30, serving as a library, as required.

The migration manager 30 is a library operating in cooperation with the filter drivers 10B and 20B. The migration manager 30 changes the destination of an I/O request received by the filter driver 10B or 20B, as required, depending on the type of the I/O request. The migration manager 30 then transfers the I/O request. Furthermore, the migration manager 30 uses the bit map 30A, composed of the bits corresponding to the data blocks for the source volume 10, to record, for each data block, whether or not data migration is completed. The migration manager 30 thus manages the data migration status.

The registry 40 stores migration information allowing the determination of the volume from which the data is to be migrated and the volume to which the data is to be migrated. The registry 40 is used to re-set the migration information for the migration manager 30 when the server with the present apparatus mounted therein is reactivated.

The business application 50 specifies a drive letter or the like for the volume used and issues an I/O request intended for the volume.

The OS pre-assigns (pre-maps) a drive letter or the like for the volume used by the business application 50. The OS issues the I/O request to the device node corresponding to the volume to which the driver letter or the like for the destination of I/O requests issued by the business application 50 is assigned.

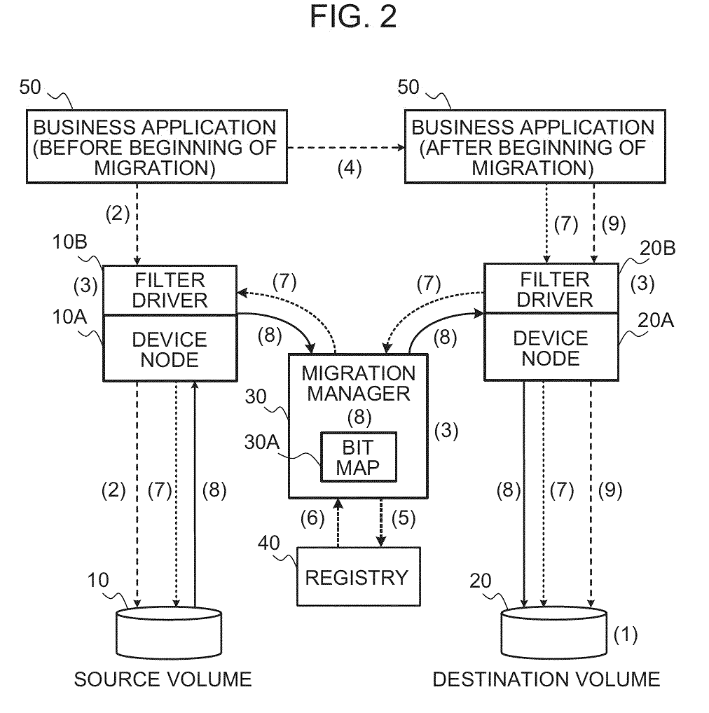

The procedures of applying the present data migration apparatus to migrate data will be described with reference to FIG. 2. In the procedures described below, the OS installed in the server with the present data migration apparatus mounted therein may be Windows (registered trade mark) by way of example. However, the present data migration mechanism is also applicable to a server in which a different OS is installed. Furthermore, the parenthesized numbers in the following description correspond to the parenthesized numbers in FIG. 2. (1) The system administrator creates a destination volume 20 with the same size as that of the source volume 10 and formats the destination volume 20 using the same file system as that for the source volume 10. (2) The I/O request issued from the business application 50 is issued to the device node 10A based on the drive letter or the like assigned by the OS. Here, the system administrator temporarily stops the processing executed by the business application 50. (3) Moreover, the system administrator installs the migration manager 30 and then installs the filter drivers 10B and 20B so that the filter drivers 10B and 20B execute cooperative processing using the migration manager 30 as a library. The system administrator then reactivates the server in order to, for example, initialize the destination volume 20 and enable the functions of the installed migration manager 30 and filter drivers 10B and 20B. When the server is reactivated, the OS loads the migration manager 30, serving as a library, and further loads the filter drivers 10B and 20B. (4) Here, the system manager issues a drive letter or the like switching command to the OS in order to switch the assignment of the drive letter or the like from the source volume 10 to the destination volume 20. When the drive letter or the like switching command is issued, the OS switches the assignment of the drive letter or the like from the source volume 10 to the destination volume 20. Specifically, the OS cancels the assignment of the drive letter or the like to the source volume 10 (e.g., DeleteVolumeMountPoint( )) and instead assigns the drive letter or the like to the destination volume 20 (e.g., SetVolumeMountPoint( )).

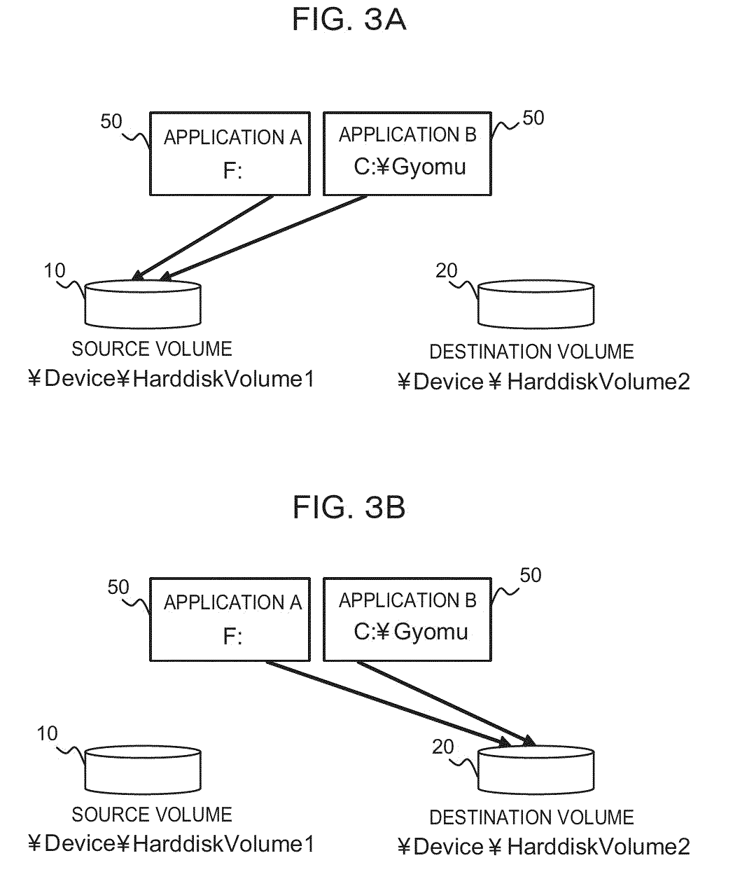

FIG. 3A and FIG. 3B are diagrams illustrating how the OS reassigns the drive letter or the like. Before the drive letter or the like switching command is executed, the drive letter “F:” and mount point “C:\Gyomu” to which the business application 50 (applications A and B) issues I/O requests are both assigned to the source volume 10 (e.g., \Device\HarddiskVolume1) by the OS as illustrated in FIG. 3A. Then, issuing the drive letter or the like switching command allows both the drive letter “F:” and the mount point “C:\Gyomu” to be assigned to the destination volume 20 (e.g., \Device\HarddiskVolume2) as illustrated in FIG. 3B. Now, FIG. 2 will be described again. (5) To notify the migration manager 30 that a data migration process is to be started, the system administrator issues a migration start command with migration information specified, that is, with the source volume 10 and the destination volume 20 specified as a data migration source and a data migration destination, respectively. When the migration start command is issued, the migration manager 30 records the migration information in the registry 40. Then, the system administrator reactivates the server. (6) When the server is reactivated, the migration manager 30 reads the migration information from the registry 40 and registers the source volume 10 and the destination volume 20 in the memory as a data migration source and a data migration destination, respectively.

The procedures (5) and (6) will be described in further detail. That is, the system administrator issues the migration start command with the drive letters or the like specified therein; the drive letters or the like are assigned to the source volume 10 and the destination volume 20, respectively. The migration manager 30 records the migration information with the drive letters or the like specified therein, in the registry 40. When the server is reactivated, the migration manager 30 reads the migration information from the registry 40. During the reactivation, the OS functions to notify the filter driver 10B of the drive letter or the like assigned to the source volume 10, as a mount request. Similarly, the filter driver 20B is notified of the drive letter or the like assigned to the destination volume 20, as a mount request. Each of the filter drivers 10B and 20B provides the migration manager 30 with information associating the drive letter or the like assigned to the volume corresponding to the filter driver with physical volume information that is an identifier enabling the volume to be physically identified. Based on the drive letters or the like for the source volume 10 and destination volume 20 contained in the physical volume information and the migration information, the migration manager 30 determines and registers the physical volume information on the source volume 10 and the destination volume 20 in the memory. (7) When the source volume 10 and the destination volume 20 are registered by the migration manager 30, the filter driver 10B and the filter driver 20B subsequently pass I/O requests to the migration manager 30. On the other hand, the migration manager 30 changes the destination of each of the I/O requests depending on the type of the I/O request.

In (4) described above, the destination of the I/O request issued by the business application 50 is switched to the device node 20A of the destination volume 20. Thus, in this stage, substantially only the I/O request from the filter driver 20B is passed to the migration manager 30. When the I/O request is for execution of a read or write process on the data stored in the storage, the destination of the I/O request is changed to the device node 10A of the source volume 10. The I/O request is thus transferred to the device node 10A. Furthermore, when the I/O request is for setting the volume attribute, the device node 20A of the destination volume remains the destination of the I/O request. The I/O request is thus transmitted to the device node 20A. Moreover, if the I/O request is for volume application notification or the like, the destination of the I/O request is set to both the device node 20A of the destination volume 20 and the device node 10A of the source volume 10. The I/O request is thus transmitted to the device node 20A and to the device node 10A. In (5) described above, the server is reactivated partly in order to transmit and transfer all of volume application notifications or the like including those issued during the activation of the OS. The transmissions and transfers are thus performed in order to ensure that before completion of data migration, the same application notifications or the like have been issued to both the source and destination volumes.

In this state, the system administrator allows the business application 50 to resume the processing.

(8) The system administrator issues a background copy command in order to allow the data in the source volume 10 to be copied to the destination volume 20. Issuing the background copy command allows the migration manager 30 to background-copy all of the data stored in the source volume 10, to the destination volume 20, in parallel with the processing by the business application 50. Furthermore, the migration manager 30 records the data in the bit map 30A so as to enable determination of which of the data blocks into which the data in the source volume 10 is partitioned and which correspond to regions of the same size has been copied. Moreover, during the background copying, when the business application 50 issues a write request intended for data already copied from the source volume 10 to the destination volume 20, the migration manager 30 executes the following processing. That is, in accordance with the write request, a write process (updating) is executed on the data in the source volume 10. On the other hand, those of the bits in the bit map 30A which correspond to data blocks to which the written data belongs are determined not to have been copied yet and are thus recorded again. Then, with reference to the bit map 30A, the migration manager 30 continues the background copying until the bits corresponding to all the data blocks are copied. (9) Under the condition that all of the data stored in the source volume 10 has been background-copied to the destination volume 20, the setting for the transfer of the I/O request is automatically changed. Specifically, the transfer of the I/O request to the device node 10A of the source volume 10 is stopped. Thus, the I/O request issued to the destination volume 20 is transmitted to the device node 20A of the destination volume 20 without change. In this stage, the data migration is completed. (10) After the data migration is completed, the system administrator may reutilize the source volume 10 as required. Furthermore, the system administrator may dynamically remove a disk based on a plug and play specification according to which the OS or the like automatically recognizes peripheral devices to assign resources to the peripheral devices.

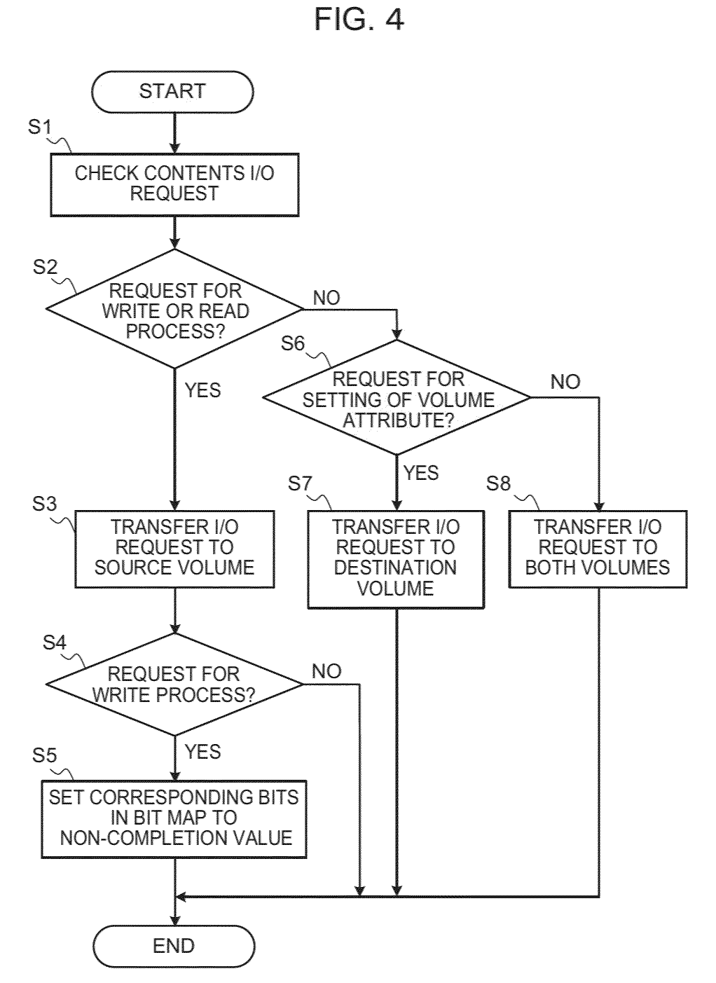

Now, with reference to the flowchart shown in FIG. 4, the contents of processing which is executed by the migration manager 30 when the business application 50 issues an I/O request will be described.

In step 1 (denoted as 51 in FIG. 4; this also applies to the following description), the type of the issued I/O request is checked.

Step 2 determines whether or not the I/O request is for execution of a read or write process on the data stored in the volume. If the I/O request is for execution of a read or write process on the data stored in the volume, the processing proceeds to step 3 (Yes). Otherwise, the processing proceeds to step 6 (No).

In step 3, the destination of the I/O request is changed to the device node 10A of the source volume 10. The I/O request is transferred to the device node 10A. In accordance with the request for a read or write process, the device node 10A executes the read or write process on the source volume 10.

Step 4 further determines whether or not the I/O request is for execution of a write process. If the I/O request is for execution of a write process, the processing proceeds to step 5 (Yes). If the I/O request is not for execution of a write process, the processing is terminated.

In step 5, those of the bits included in the bit map 30A which correspond to data blocks to which the target data of the write process request belongs are set to a value indicating that copying has not been completed yet (the value is hereinafter referred to as a “non-completion value”).

Step 6 determines whether or not the I/O request is for setting the volume attribute. If the I/O request is for setting the volume attribute, the processing proceeds to step 7 (Yes). Otherwise, the processing proceeds to step 8 (No).

In step 7, the I/O request is transmitted to the device node 20A of the destination volume 20 without change. In accordance with the request for setting the volume attribute, the device node 20A executes a process for setting the volume attribute, on the destination volume.

In step 8, the I/O request is transferred to the device node 10A of the source volume 10 and also to the device node 20A of the destination volume 20 without change. The condition under which the processing in step 8 is executed is that the I/O request is for volume application notification or the like. Furthermore, in accordance with the request for volume application notification or the like, the device nodes 10A and 20A execute a process for volume application notification on the resource volume 10 and the destination volume 20, respectively.

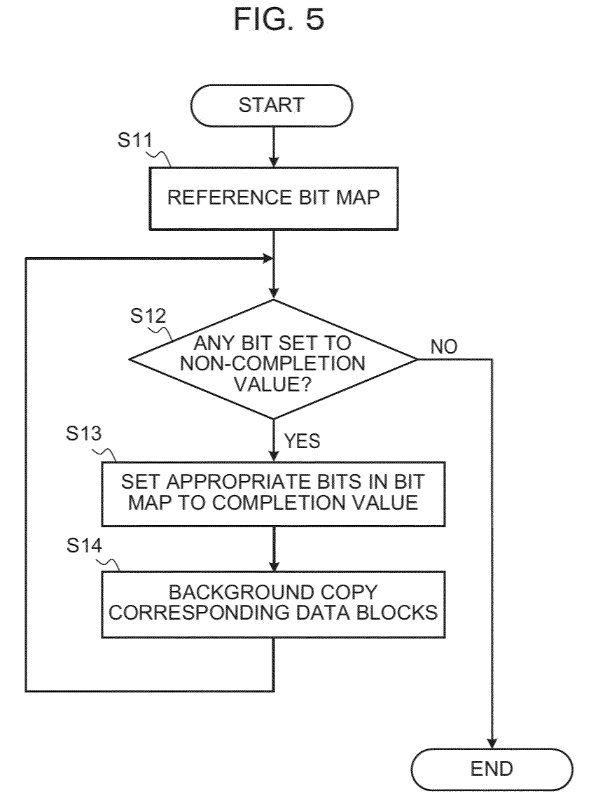

Now, with reference to the flowchart illustrated in FIG. 5, the contents of the background copy process executed by the migration manager 30 will be described. The process is executed when the system manager issues the migration start command.

In step 11, the bit map 30A is referenced. Before the background copying, all the bits in the bit map are set to the non-completion value.

Step 12 determines whether or not any of the bits in the bit map 30A has the non-completion value. If any of the bits has the non-completion value, the processing proceeds to step 13 (Yes). Otherwise, the processing is terminated.

In step 13, the bit with the non-completion value is set to a value indicating that copying is completed (the value is hereinafter referred to as a “completion value”).

In step 14, the data in the data blocks in the source volume 10 which correspond to the bits set to the completion value in step 13 is copied from the source volume 10 to the destination volume 20. Then, the processing returns to step 12.

Now, the background copy process using the bit map 30A will be specifically described. Before data copying, all the bits in the bit map 30A are set to “1”, which is the non-completion value”. The migration manager 30 copies the data blocks in the source volume 10 to the destination volume 20. The migration manager 30 then changes the bits corresponding to the data blocks to “0”, which is the completion value. Furthermore, during the background copying, when the business application 50 issues a request for execution of a write process on the data already copied from the source volume 10 to the destination volume 20, that is, the data belonging to the data blocks for which the bits in the bit maps 30A are set to “0”, the bits are set back to “1”.

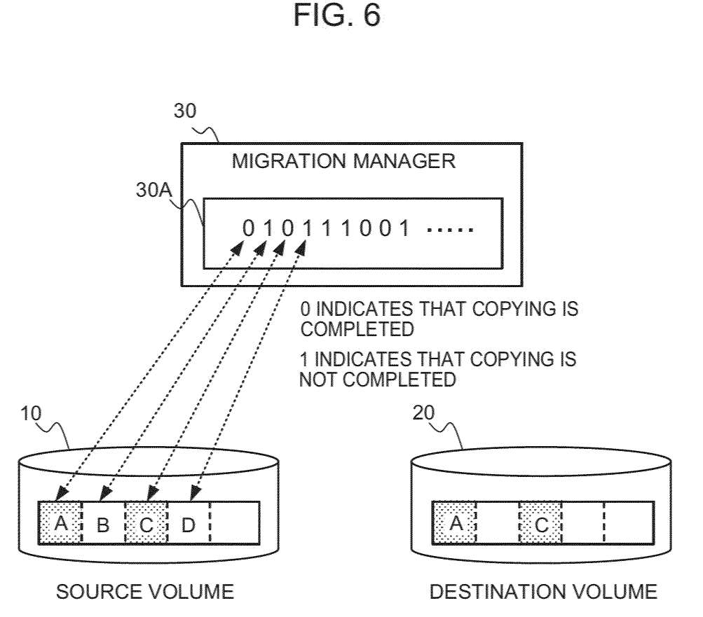

FIG. 6 is a diagram illustrating the relationship between the bit map 30A and the source volume 10 and the destination volume 20. As illustrated in FIG. 6, each of the bits in the bit map 30A corresponds to one of the data blocks stored in the source volume 10. FIG. 6 illustartes that the bits corresponding to data blocks A and C in the source volume 10 are set to “0”, indicating that the copying of the data blocks A and C to the destination volume 20 is already completed. On the other hand, FIG. 6 illustrates that the bits corresponding to data blocks B and D in the source volume 10 are set to “1”, indicating that the copying of the data blocks B and D to the destination volume 20 is not completed yet.

According to the data migration apparatus described above, an I/O request issued to the device node 20A by the business application 50 during data copying is directed to the device node 10A of the source volume 10 or the device node 20A of the destination volume 20 depending on the type of the I/O request. At this time, in particular, a request for execution of a read or write process on data is transferred to the device node 10A, and then the read or write process is executed on the source volume 10. Thus, even during data copying, the data read and write processes may be reliably achieved regardless of whether or not the copying of target data of the read and write processes has been completed. Furthermore, when a write process is requested during data copying, the target data of the write process is copied to the destination volume 20 again. Thus, even though the write process is executed on the data already copied to the destination volume 20, possible data mismatch between the source volume 10 and the destination volume 20 is prevented. Consequently, even if the destination of the I/O request from the business application is switched to the device node of the destination volume before the beginning of the data copying, data migration may be properly achieved. The system administrator need not switch the destination of the I/O request from the business application to the destination volume after the data copying or monitor when the data copying is completed.

As described above, the system administrator need not monitor the data copying for which completion cannot be predicted to find out when the copying is completed. Thus, even if the computer system as a whole performs a plurality of data migration operations, setting a relevant operation schedule is easy.

Moreover, when the I/O request issued by the business application 50 is for setting the volume attribute, the I/O request is not transferred to the device node 10A of the source volume 10 but is transmitted to the device node 20A of the destination volume 20 without change. On the other hand, if the I/O request is for setting the volume application, the I/O request is transferred to the device node 10A of the source volume 10 and transmitted to the device node 20A of the destination volume 20 without change. In this manner, only information required for each of the source volume 10 and the destination volume 20 is transmitted depending on the type of the I/O request. Thus, possible mismatch in the setting the source volume 10 and the destination volume 20 may be avoided.

In the above-described embodiment, the OS changes the assignment of the drive letter or the like in order to change the destination of the I/O request issued by the business application 50 from the source volume 10 to the destination volume 20. However, the present data migration mechanism is not limited to this method. For example, the settings in the business application 50 may be changed so as to switch the destination of the I/O request from the source volume 10 to the destination volume 20.

The data processing method described in the present embodiment may be implemented by executing a prepared program in a computer such as a personal computer or a workstation. The program is recorded in a computer-readable recording medium such as a hard disk, a flexible disk, a CD-ROM, an MO, or a DVD, and read from the recording medium by the computer for execution. Furthermore, the program may be a medium that can be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. A computer-readable recording medium storing a data migration program that migrates data from a first storage to a second storage, the program causing a computer to execute:
switching a destination of an I/O request issued by a business application from a device node of the first storage to a device node of the second storage;
copying data stored in the first storage to the second storage;
transferring the I/O request to the device node of the first storage when the I/O request issued by the business application during the copying of the data is for execution of a read process or a write process at least on the data stored in the storage;
executing the read or write process on the first storage in accordance with the request for execution of the read or write process transferred to the device node of the first storage;
re-copying target data of the write process from the first storage to the second storage when the write process executed on the first storage is intended at least for the data already copied from the first storage to the second storage; and
stopping the transfer of the I/O request to the device node of the first storage when the copying of the data to the second storage is completed.

2. The computer-readable recording medium according to claim 1, the program further causing the computer to execute:
transmitting the I/O request to the device node of the second storage when the I/O request issued by the business application during the copying of the data is for setting a storage attribute; and
executing a process of setting the storage attribute for the first storage in accordance with the request for setting the storage attribute transmitted to the device node of the second storage.

3. The computer-readable recording medium according to claim 1, the program further causing the computer to execute:
transmitting the I/O request to the device node of the second storage and transferring the I/O request to the device node of the first storage when the I/O request to be issued to the device node of the second storage is for storage application notification; and
executing a storage application notification process on the second storage in accordance with the request for storage application notification transmitted to the device node of the second storage, while executing the storage application notification process on the first storage in accordance with the request for storage application notification transferred to the device node of the first storage.

4. The computer-readable recording medium according to claim 2, the program further causing the computer to execute:
transmitting the I/O request to the device node of the second storage and transferring the I/O request to the device node of the first storage when the I/O request to be issued to the device node of the second storage is for storage application notification; and
executing a storage application notification process on the second storage in accordance with the request for storage application notification transmitted to the device node of the second storage, while executing the storage application notification process on the first storage in accordance with the request for storage application notification transferred to the device node of the first storage.

5. The computer-readable recording medium according to claim 1, wherein the copying procedure references a bit map comprising bits corresponding to respective data blocks in the first storage, each bit map showing one of a non-completion value indicating that the copying of the data to the second storage is not completed or a completion value indicating that the copying of the data is completed, and copies data to the second storage until all the bits provided in the bit map are set to the completion value.

6. The computer-readable recording medium according to claim 2, wherein the copying procedure references a bit map comprising bits corresponding to respective data blocks in the first storage, each bit map showing one of a non-completion value indicating that the copying of the data to the second storage is not completed or a completion value indicating that the copying of the data is completed, and copies data to the second storage until all the bits provided in the bit map are set to the completion value.

7. The computer-readable recording medium according to claim 3, wherein the copying procedure references a bit map comprising bits corresponding to respective data blocks in the first storage, each bit map showing one of a non-completion value indicating that the copying of the data to the second storage is not completed or a completion value indicating that the copying of the data is completed, and copies data to the second storage until all the bits provided in the bit map are set to the completion value.

8. The computer-readable recording medium according to claim 4, wherein the copying procedure references a bit map comprising bits corresponding to respective data blocks in the first storage, each bit map showing one of a non-completion value indicating that the copying of the data to the second storage is not completed or a completion value indicating that the copying of the data is completed, and copies data to the second storage until all the bits provided in the bit map are set to the completion value.

9. The computer-readable recording medium according to claim 5, wherein the copying procedure changes bits in the bit map corresponding to data blocks for which the copying of the data to the second storage is completed, to the completion value, and when the write process is executed on the data already copied from the first storage to the second storage, changes bits corresponding to data blocks to which target data of the write process belongs, to the non-completion value.

10. The computer-readable recording medium according to claim 1, wherein the switching procedure switches the device node of the storage associated, by an operating system, with a drive letter or a mount point indicating the destination of the I/O request issued by the business application, from the device node of the first storage to the device node of the second storage.

11. The computer-readable recording medium according to claim 2, wherein the switching procedure switches the device node of the storage associated, by an operating system, with a drive letter or a mount point indicating the destination of the I/O request issued by the business application, from the device node of the first storage to the device node of the second storage.

12. The computer-readable recording medium according to claim 3, wherein the switching procedure switches the device node of the storage associated, by an operating system, with a drive letter or a mount point indicating the destination of the I/O request issued by the business application, from the device node of the first storage to the device node of the second storage.

13. The computer-readable recording medium according to claim 4, wherein the switching procedure switches the device node of the storage associated, by an operating system, with a drive letter or a mount point indicating the destination of the I/O request issued by the business application, from the device node of the first storage to the device node of the second storage.

14. The computer-readable recording medium according to claim 5, wherein the switching procedure switches the device node of the storage associated, by an operating system, with a drive letter or a mount point indicating the destination of the I/O request issued by the business application, from the device node of the first storage to the device node of the second storage.

15. The computer-readable recording medium according to claim 9, wherein the switching procedure switches the device node of the storage associated, by an operating system, with a drive letter or a mount point indicating the destination of the I/O request issued by the business application, from the device node of the first storage to the device node of the second storage.

16. A data migration method executed by a computer migrating data from a first storage to a second storage, the method comprising:
switching a destination of an I/O request issued by a business application from a device node of the first storage to a device node of the second storage;
copying data stored in the first storage to the second storage;
transferring the I/O request to the device node of the first storage when the I/O request issued by the business application during the copying of the data is for execution of a read process or a write process at least on the data stored in the storage;
executing the read or write process on the first storage in accordance with the request for execution of the read or write process transferred to the device node of the first storage;
re-copying the data of the write process from the first storage to the second storage when the write process executed on the first storage is intended at least for the data already copied from the first storage to the second storage; and
stopping the transfer of the I/O request to the device node of the first storage when the copying of the data to the second storage is completed.

17. A data migration apparatus migrating data from a first storage to a second storage, the apparatus comprising:
a switching unit for switching a destination of an I/O request issued by a business application from a device node of the first storage to a device node of the second storage;
a copying unit for copying data stored in the first storage to the second storage;
a transferring unit for transferring the I/O request to the device node of the first storage when the I/O request issued by the business application during the copying of the data is for execution of a read process or a write process at least on the data stored in the storage;
an executing unit for executing the read or write process on the first storage in accordance with the request for execution of the read or write process transferred to the device node of the first storage;
a re-copying unit for re-copying the data of the write process from the first storage to the second storage when the write process executed on the first storage is intended at least for the data already copied from the first storage to the second storage; and
a stopping unit for stopping the transfer of the I/O request to the device node of the first storage when the copying of the data to the second storage is completed.
